(19) United States
(12) Patent Application Publication
(10) Pub. No.: US 2025/0274868 A1
(43) Pub. Date: Aug. 28, 2025

(54) LOW POWER WAKE-UP SIGNAL

(71) Applicant: InterDigital Patent Holdings, Inc., Wilmington, DE (US)

(72) Inventors: Erdem Bala, East Meadow, NY (US); Virgil Comsa, Montreal (CA); Brian Martin, Farnham (GB); Moon-il Lee, Melville, NY (US); Paul Marinier, Brossard (CA); Janet A. Stern-Berkowitz, Little Neck, NY (US); Frank LaSita, Long Beach, NY (US)

(73) Assignee: InterDigital Patent Holdings, Inc., Wilmington, DE (US)

(21) Appl. No.: 18/859,905

(22) PCT Filed: Apr. 26, 2023
(86) PCT No.: PCT/US2023/019906

§ 371 Date: Oct. 24, 2024

Related U.S. Application Data
(60) Provisional application No. 63/334,870, filed on Apr. 26, 2022.

(51) Int. Cl. H04W 52/02; H04L 1/00; H04L 27/02; H04W 76/28

(52) U.S. Cl. CPC H04W 52/0235; H04L 1/0068; H04L 27/02; H04W 76/28

(57) ABSTRACT

A wireless transmit/receive unit (WTRU) may determine the number of information bits of a signal by, for example, determining a puncturing scheme based on a power parameter. The WTRU may determine orthogonal frequency division multiplexing (OFDM) resources. The WTRU may determine, based on a power parameter associated with a transmission, a puncturing scheme associated with these OFDM resources. The WTRU may determine, based on the puncturing scheme, a number of information bits associated with the OFDM resources. The WTRU may decode the transmission based on the number of information bits. The WTRU may determine an on-resource of the OFDM resources. The WTRU may determine an off-resource of the OFDM resources. The WTRU may determine the on-resource and the off-resource based on a transmission power threshold. The WTRU may determine the puncturing scheme based on the determined on-resource and off-resource.

### CROSS-REFERENCE TO RELATED APPLICATIONS

This application claims the benefit of provisional U.S. patent application No. 63/334,870, filed Apr. 26, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein associated with a wireless transmit/receive unit (WTRU) configured to determine the number of information bits of a signal by, for example, determining a puncturing scheme based on a power parameter.

Orthogonal frequency division multiplexing (OFDM) resources may be used for transmission. The WTRU may determine the OFDM resources. The WTRU may determine, based on a power parameter associated with a transmission, a puncturing scheme associated with these OFDM resources. The WTRU may determine, based on the puncturing scheme, a number of information bits associated with the OFDM resources. The WTRU may decode the transmission based on the number of information bits. The number of information bits may indicate a numerical quantity of the information bits.

The WTRU may determine an on-resource of the OFDM resources. The WTRU may determine an off-resource of the OFDM resources. The WTRU may determine the on-resource and the off-resource based on a transmission power threshold. The WTRU may determine the puncturing scheme based on the determined on-resource and off-resource. In examples, the WTRU may determine, based on the transmission power threshold, the number of on-resources of the OFDM resources and the number of off-resources of the OFDM resources, which may be used to determine the puncturing scheme.

The on-resource and the off-resource may be determined based on average transmission powers and the transmission power threshold. In examples, a first average transmission power over a duration of the on-resource may be greater than or equal to the transmission power threshold. A second average transmission power over a duration of the off-resource may be less than the transmission power threshold.

The power parameter associated with the transmission may include a power variation associated with the transmission. The WTRU may determine an on-off resource pattern based on one or more power variations associated with the transmission. The WTRU may determine the puncturing scheme based on the on-off resource pattern. In examples, the puncturing scheme may indicate a temporal point associated with the on-resource. The WTRU may decode the transmission based on the temporal point associated with the on-resource.

The transmission may include first information and second information. In examples, the transmission may be an on-off keyed low power wake-up signal. The first information may be indicated by an on-off keying associated with the on-off keyed low power wake-up signal and indicate whether the WTRU is to wake up in a discontinuous reception (DRX) mode. The second information may be included in the information bits. In examples, the number of the information bits may be determined based on the number of on-resources that is indicated by the puncturing scheme. The information bits may indicate, for example, an identifier associated with the WTRU.

The WTRU may include multiple receivers, for example, a receiver and a low-power receiver. When the first information includes an activation-deactivation indication, the first information may indicate to the WTRU whether the WTRU is to deactivate the low-power receiver and activate the receiver.

The WTRU may decode the information bits using discrete fourier transform spread orthogonal frequency division multiplexing demodulation.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of ON/OFF keying (OOK) signal.

FIG. 2A illustrates an example DFT.

FIG. 3 is a diagram illustrating an example of ON/OFF durations (e.g., ON/OFF intervals after IDFT of an OFDM modulator).

FIG. 4 illustrates an example of a determination (e.g., a dynamic determination) of the number of information bits.

FIG. 5 illustrates an example of a determination (e.g., a dynamic determination) of the number of information bits.

### DETAILED DESCRIPTION

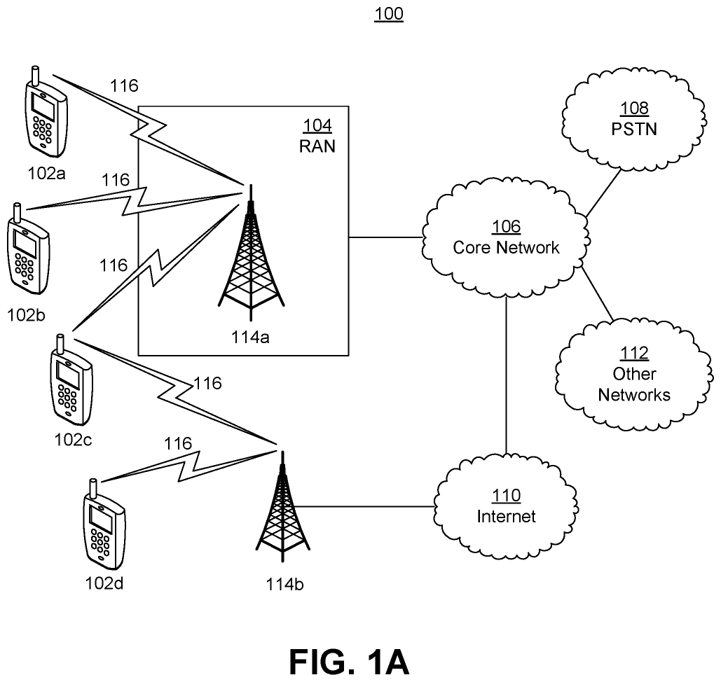

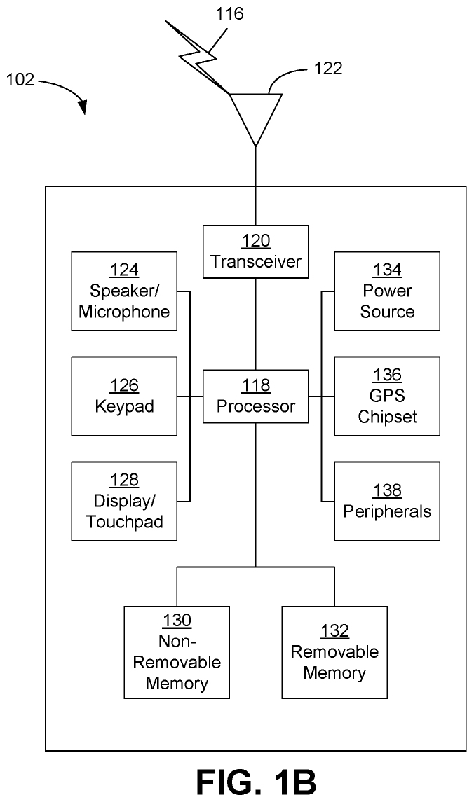

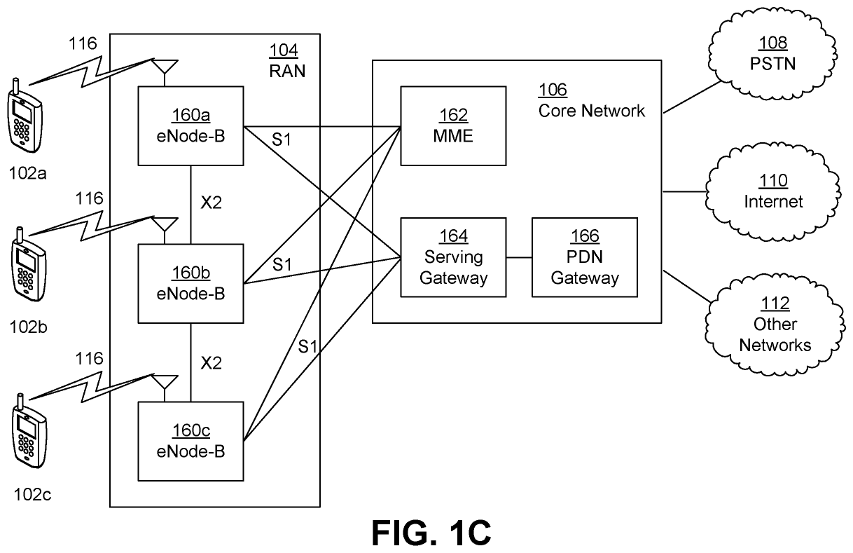

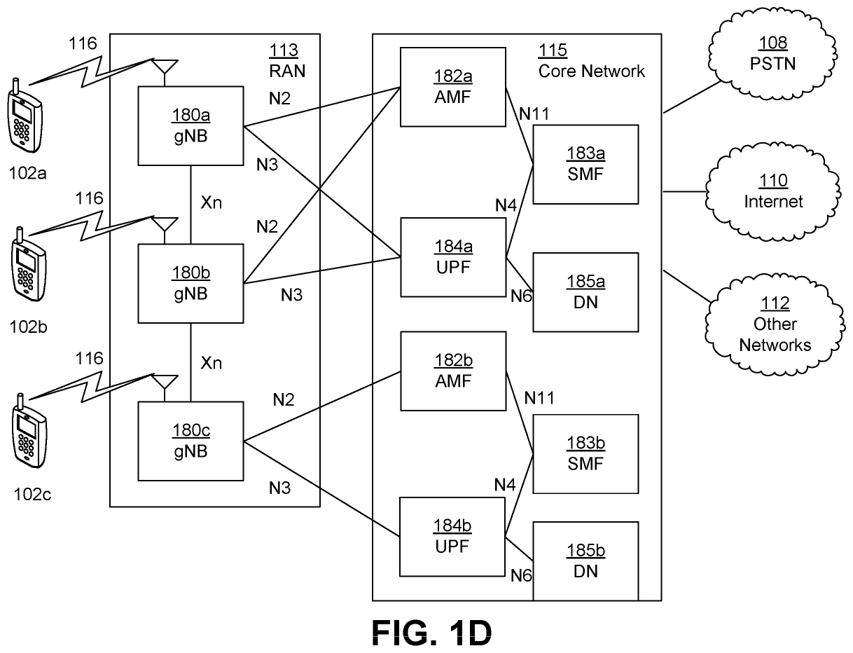

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein associated with a wireless transmit/receive unit (WTRU) configured to transmit multiple levels of information in a low power wake-up signal (LP WUS). A first level of information may include ON/OFF symbol(s). A second level of information may include information bits embedded in the LP WUS.

In examples, a WTRU may be configured to receive an LP WUS. The LP WUS may include ON/OFF symbols. The LP WUS may also include embedded information bits. The WTRU may determine first information based on the ON/OFF symbols. The WTRU may determine second information based on the information bits embedded in the LP WUS. The WTRU may obtain an indication of whether the WTRU is to wake up based on the first information and the second information. The LP WUS may include a signal or a portion of the signal transmitted in a specific bandwidth with a predefined modulation. The WTRU may receive an indication for monitoring for the LP WUS and monitor the LP WUS based on the received indication, for example, before the WTRU receives the LP WUS. The WTRU may receive configuration information associated with the LP WUS in system information or in a radio resource control (RRC) message.

The first information and the second information may be independent from each other or related to each other. In examples, the first information may include an indication of whether to wake up, and the second information may include an identification information of the WTRU or of a group of WTRUs to which the WTRU belongs. The WTRU may use the first information and the second information to determine whether the indication of whether to wake up is for the WTRU. The first information may be determined using power detection, and the second information may be determined using discrete Fourier transform spread orthogonal frequency division multiplexing or using single-carrier modulation.

Configuration of the LP WUS including procedure(s) where a main receiver turns off and a low-power receiver is used to start monitoring the LP WUS may be described in one or more examples herein.

Systems, methods, and instrumentalities are described herein associated with a wireless transmit/receive unit (WTRU) configured to determine the number of information bits of a signal by, for example, determining a puncturing scheme based on a power parameter.

Orthogonal frequency division multiplexing (OFDM) resources may be used for transmission. The WTRU may determine the OFDM resources. The WTRU may determine, based on a power parameter associated with a transmission, a puncturing scheme associated with these OFDM resources. The WTRU may determine, based on the puncturing scheme, a number of information bits associated with the OFDM resources. The WTRU may decode the transmission based on the number of information bits. The number of information bits indicates a numerical quantity of the information bits.

The WTRU may determine an on-resource of the OFDM resources. The WTRU may determine an off-resource of the OFDM resources. The WTRU may determine the on-resource and the off-resource based on a transmission power threshold. The WTRU may determine the puncturing scheme based on the determined on-resource and off-resource. In examples, the WTRU may determine, based on the transmission power threshold, the number of on-resources of the OFDM resources and the number of off-resources of the OFDM resources, which may be used to determine the puncturing scheme.

The on-resource and the off-resource may be determined based on average transmission powers and the transmission power threshold. In examples, a first average transmission power over a duration of the on-resource may be greater than or equal to the transmission power threshold. A second average transmission power over a duration of the off-resource may be less than the transmission power threshold.

The power parameter associated with the transmission may include a power variation associated with the transmission. The WTRU may determine an on-off resource pattern based on one or more power variations associated with the transmission. The WTRU may determine the puncturing scheme based on the on-off resource pattern. In examples, the puncturing scheme may indicate a temporal point associated with the on-resource. The WTRU may decode the transmission based on the temporal point associated with the on-resource.

The transmission may include first information and second information. In examples, the transmission may be an on-off keyed low power wake-up signal. The first information may be indicated by an on-off keying associated with the on-off keyed low power wake-up signal and indicate whether the WTRU is to wake up in a discontinuous reception (DRX) mode. The second information may be included in the information bits. In examples, the number of the information bits may be determined based on the number of on-resources that is indicated by the puncturing scheme. The information bits may indicate, for example, an identifier associated with the WTRU.

The WTRU may include multiple receivers, for example, a receiver and a low-power receiver. When the first information includes an activation-deactivation indication, the first information may indicate to the WTRU whether the WTRU is to deactivate the low-power receiver and activate the receiver.

The WTRU may decode the information bits using discrete fourier transform spread orthogonal frequency division multiplexing demodulation.

In some examples, WTRU(s) may periodically wake up once per DRX cycle, which dominates the power consumption in periods with no signalling or data traffic. If a WTRU wakes up when (e.g., only when) it is triggered (e.g., via paging), the power consumption may be reduced. A wake-up signal may be used to trigger a main radio (e.g., a main receiver) and a separate receiver (e.g., a low-power receiver) which has the ability to monitor the wake-up signal with a low power consumption (e.g., an ultra-low power consumption). The main radio may be used for data transmission and/or reception, which may be turned off or set to sleep (e.g., set to deep sleep) unless it is turned on. The power consumption for monitoring WUS(s) may depend on the design of the WUS(s) and/or the hardware module of the receiver (e.g., the wake-up receiver) used for signal detecting and processing. One or more examples herein may be used in association with LP WUS(s)/wakeup receiver(s) (WUR(s)) for power-sensitive, small form-factor devices including Internet-of-Things (IoT) use cases (e.g., industrial sensors, controllers) and/or wearables, and/or other use cases (e.g., XR/smart glasses, smart phones).

In some examples, existing signals are not required to be used as WUS(s). One or more examples herein may be used to operate in a cell (e.g., a cell supporting legacy WTRUs). One or more of the following may be improved: detection performance, coverage, power saving, or WTRU complexity.

Physical downlink control channel (PDCCH) and/or search spaces may be used in one or more examples as described herein (e.g., the one or more examples herein may be applicable to New Radio (NR)). In a system such as NR for 5G wireless systems, a structure and/or design may be used, adopted for PDCCH, as well as physical downlink shared channel (PDSCH). One or more of slot-based, non-slot-based transmissions, or different rates of monitoring may be used for PDCCH.

A resource element group (REG) may be a building block (e.g., the smallest building block) for a PDCCH transmission. A (e.g., each) REG may include (e.g., consist of) 12 REs on one OFDM symbol in time and one resource block (RB) in frequency. In an example, 9 resource elements (REs) may be used for control information and 3 REs may be used for demodulation reference signal (DMRS), in a (e.g., each) REG. Multiple REGs (e.g., 2, 3, or 6 REGs adjacent in time or frequency) may form an REG bundle (e.g., an REG bundle is used with the same precoder), and their DMRSs may be used together for channel estimation. In an example, 6 REGs (e.g., in the format of 1, 2, or 3 REG bundles) may form one control channel element (CCE) (e.g., a CCE may be the smallest possible PDCCH). A (e.g., each) PDCCH may include (e.g., consist of) one or multiple CCEs (e.g., 1, 2, 4, 8, or 16 CCEs). The number of CCEs for a PDCCH transmission may be called its aggregation level (AL).

Mapping of REG bundles may use interleaving or non-interleaving. In the non-interleaving mapping, consecutive REG bundles (e.g., adjacent in frequency) may form a CCE, and CCEs adjacent in frequency may form a PDCCH. In the interleaving mapping, REGs may be interleaved (or permuted) before being mapped to CCEs, for example, resulting in generally non-adjacent REG bundles in one CCE and non-adjacent CCEs in one PDCCH.

A control resource set (CORESET) may be configured by or may include at least one of: i) a frequency assignment (e.g., as chunks of 6 RBs); ii) a length in time (e.g., 1-3 OFDM symbols); iii) a type of REG bundle; iv) a type of mapping from REG bundles to CCEs (e.g., whether it is interleaving or non-interleaving). In a (e.g., each) bandwidth part (BWP), there may be up to a N (e.g., 3) CORESETs. For example, there may be 12 CORESETs in 4 possible bandwidth parts.

A WTRU may monitor or may be assigned with a set of PDCCH candidates (e.g., to monitor). A set of PDCCH candidates may be monitored, for example, during the blind detection of PDCCH. A search space or a set of search spaces (e.g., for multiple aggregation levels) may be or may include a set of PDCCH candidates (e.g., a set of PDCCH candidates to monitor such as with blind detection). A (e.g., each) search space or set of search spaces may be configured by at least one of: i) an associated CORESET; ii) a number of candidates for or within an (e.g., each) aggregation level); iii) a set of monitoring occasions. The monitoring occasions may be determined by one or more of the following: a monitoring periodicity (e.g., in terms of slots); a monitoring offset; a monitoring pattern (e.g., with 14 bits corresponding to the possible patterns of symbols inside a slot).

A discontinuous reception (DRX) mode (e.g., a DRX idle mode) and/or paging may be used in one or more examples herein (e.g., the one or more examples that are applicable to NR). A WTRU may use DRX in an RRC_IDLE and/or an RRC_INACTIVE state, for example, to reduce power consumption. The WTRU may monitor, for example, one paging occasion (PO) per DRX cycle. A PO may include a set of PDCCH monitoring occasions. A PO may include (e.g., consist of) multiple time slots (e.g., subframe or OFDM symbol) where paging downlink control information (DCI) may be sent. A paging frame (PF) may be a radio frame and/or may contain one or multiple POs or starting point(s) of one or more POs.

In some example multi-beam operation(s), a WTRU may assume that the same paging message and the same short message are repeated in some or all transmitted beams (e.g., the selection of the beam(s) for the reception of the paging message and short message may be configured for a WTRU). The paging message may be the same for RAN initiated paging and CN initiated paging.

The WTRU may initiate an RRC connection resume procedure based on (e.g., upon) receiving RAN initiated paging. If the WTRU receives a CN initiated paging in an RRC_INACTIVE state, the WTRU may move to an RRC_IDLE state and/or inform non-access stratum (NAS) (layer(s)).

A WTRU may monitor for or listen to the paging message, for example, to know about one or more of incoming calls, system information change(s), earthquake and tsunami warning service (ETWS) notification for ETWS capable WTRUs, commercial mobile alert system (CMAS) notification, and/or extended access barring parameters modification.

In a RRC Idle state, the WTRU may monitor short messages transmitted with paging radio network temporary identifier (P-RNTI) over DCI and/or monitor a paging channel for CN paging, for example, using 5G-S-TMSI. In an RRC inactive state, the WTRU may monitor short messages transmitted with P-RNTI over DCI and/or monitor a paging channel for CN paging, for example, using 5G-S-TMSI and RAN paging, for example, using full-RNTI. In an RRC connected state, a WTRU may monitor short messages transmitted with P-RNTI over DCI.

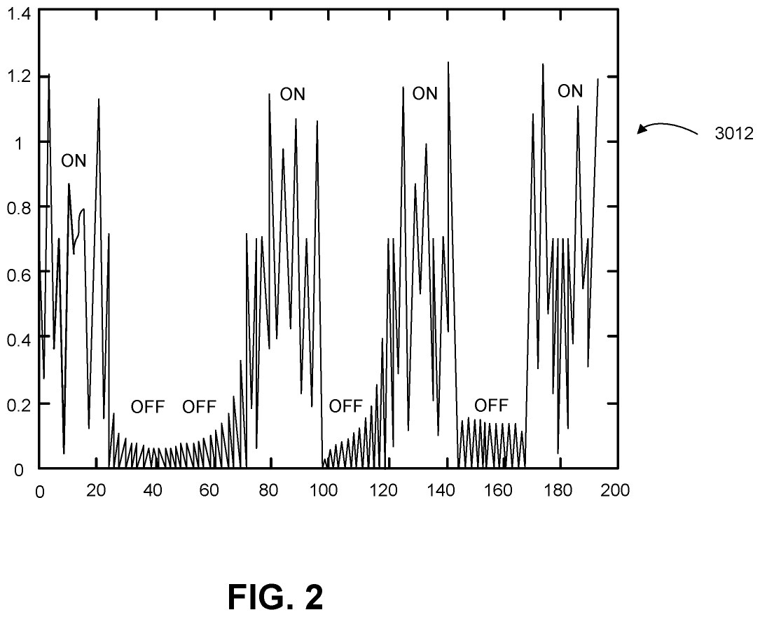

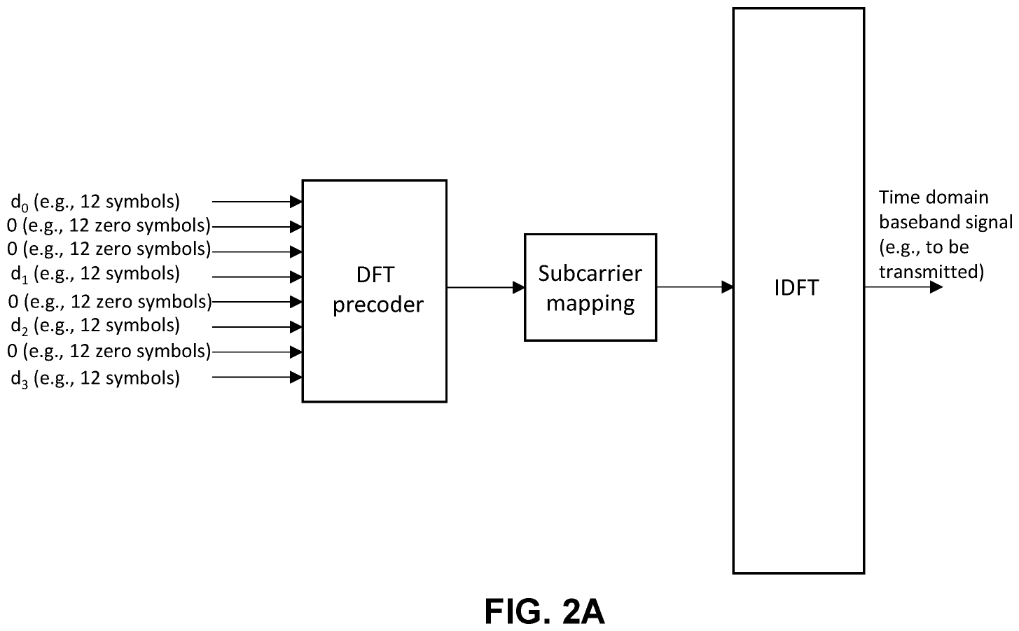

The waveform of a transmission, for example, an ON/OFF keying signal, may be shown in FIG. 2. In examples, data may be embedded in an ON/OFF keying signal. ON and OFF symbols may be used for transmission. An ON symbol may include one or more samples. An OFF symbol may include one or more samples.

The transmission may include a WUS. In examples, a WUS (e.g., a low power (LP) WUS) may be formed by a time domain signal. ON/OFF keying (OOK) may be used for the WUS. For example, an OOK signal may be transmitted using on-resources and off-resources. An on-resource may include one or more ON symbols. An off-resource may include one or more OFF symbols. For example, a time domain signal may contain ON and OFF symbols (e.g., indicating OOK). The on-resource may be associated with a first power parameter, and the off-resource may be associated with a second power parameter. A power parameter may be one or more of an average power, a total power, a power variation, etc. For example, an ON symbol may include a signal whose power and/or energy (e.g., an average power/energy, a total power/energy, etc.) in the interval over which the ON symbol is determined to be transmitted is equal to or greater than a threshold. An OFF symbol may include a signal whose power and/or energy (e.g., an average power/energy, a total power/energy, etc.) in the interval over which the OFF symbol is determined to be transmitted is less than a threshold. The power/energy of an OFF symbol may be zero.

An on-off resource pattern may be determined, for example, for a transmitted OOK signal. A WTRU may determine the on-off resource pattern based on one or more power parameters of the OOK signal. For example, the WTRU may determine the on-off resource pattern based on one or more power variations. A power variation associated with an ON symbol and an OFF symbol may be determined, for example, using one or more power parameters associated with the transmission. The power variation associated with an ON symbol and an OFF symbol may be determined based on a difference between an average power over a duration of the ON symbol and an average power over a duration of the OFF symbol. The power variation associated with an ON symbol and an OFF symbol may be determined based on a ratio of an average power over the duration of the ON symbol to an average power over the duration of the OFF symbol. In an example, a high-to-low power/energy ratio between ON and OFF symbols durations (e.g., minimum high-to-low power/energy ratio between ON and OFF symbols durations) may be defined. If a ratio of an average power over the duration of the ON symbol to an average power over the duration of the OFF symbol is greater than or equal to a minimum value (e.g., a predefined minimum value), one or more of the ON symbol, the OFF symbol, and/or a transition from the ON symbol to the OFF symbol may be determined, for example, as a part of the on-off resource pattern.

FIG. 2 is a diagram illustrating an example of ON/OFF keying (OOK) signal. FIG. 2 shows an example of a transmission (e.g., a transmitted signal). As shown in FIG. 2, the example OOK signal (e.g., transmitted or to be transmitted OOK signal) may include durations corresponding to ON symbols (e.g., ON symbol intervals) and durations corresponding to OFF symbols (e.g., OFF symbol intervals). The x-axis of the example diagram of FIG. 2 indicates time (e.g., time domain samples), and the y-axis of the example diagram of FIG. 2 indicates amplitude. In the example shown in FIG. 2, an ON or OFF symbol (e.g., each of the ON or OFF symbols) includes 24 time domain samples. The OOK signal in FIG. 2 may be associated with an on-off resource pattern (e.g., an on-off resource pattern corresponding to the OOK). The on-off resource pattern associated with the OOK signal in FIG. 2 may be ON, OFF, OFF, ON, OFF, ON, OFF, and ON. An on-resource (e.g., the ON symbol in FIG. 2) may be associated with an average power that is greater than or equal to a value (e.g., a transmission power threshold). The average power associated with the on-resource may be determined over the duration of the on-resource. An off-resource (e.g., the OFF symbol in FIG. 2) may be associated with an average power that is less than the value. The average power associated with the off-resource may be determined over the duration of the off-resource. In some examples, the OFF symbols may have zero power.

An on-resource may be associated with a first data bit (e.g., a data bit “1”), and an off-resource may be associated with a second data bit (e.g., a data bit “0”). A data bit may be represented by a resource (e.g., an ON symbol or OFF symbol). In examples, one data bit may be represented by at least one symbol (e.g., an ON/OFF symbol). For example, one ON symbol may represent data bit “1”, and one OFF symbol may represent data bit “0”. In some examples, [ON OFF] may represent data bit “1”, and [OFF ON] may represent data bit “0”. A combination of ON/OFF symbols may represent one data bit or more than one data bits.

An association of a first data bit (e.g., a data bit “1”) with an on-resource and/or an association of an off-resource with a second data bit (e.g., a data bit “0”) may be predefined. An association between a data bit with an ON symbol or OFF symbol may include mapping(s) from ON/OFF symbol(s) to data bit(s). In examples, mapping(s) from ON/OFF symbol(s) to data bit(s) may be predefined and/or known to a transmitter and a receiver.

A WTRU may include multiple receivers (e.g., multiple types of receivers). For example, the WTRU may include a first receiver and a second receiver that is a low-power receiver. The low-power receiver may be dedicated to receiving low-power signals (e.g., an LP WUS). The low-power receiver of the WTRU may be configured to consume less power than the first receiver. In examples, a WUS (e.g., an LP WUS) may be detected with a low-power receiver (e.g., a receiver that consumes less power than a conventional receiver). In examples, the low-power receiver may include a WUR. A WUR may be associated with a simpler design than the first receiver (e.g., a regular receiver). The WUR may detect a symbol using the power of the received signal or the frequency. In some examples, the WUR may not be expected to perform channel decoding, channel estimation, or FFT.

In one or more examples herein, an LP WUS may refer to a whole signal transmitted in a specific bandwidth with a predefined waveform and/or modulation (e.g., ON/OFF keying), or a part of such signal. In one or more examples herein, LP WUS(s) may be used as an example of WUS(s) and/or an example of low power signal(s).

In examples, multiple information, multiple types of information, and/or multiple levels of information (e.g., at least two levels of information) may be included (e.g., encoded) in a transmission (e.g., the example OOK signal in FIG. 2). The transmission may include a wake-up signal (e.g., an LP WUS). For example, first information (e.g., a first level of information, a first type of information, etc.) may be indicated by an on-off resource pattern (e.g., an on-off keying associated with an on-off keyed low power wake-up signal). The first information may be included (e.g., encoded) in the ON/OFF symbols. The first information may be determined based on the association of a first data bit (e.g., a data bit “1”) with an on-resource and/or the association of a second data bit (e.g., a data bit “0”) with an off-resource. For example, the first information may be retrieved by using a mapping from ON/OFF symbols to data bits (e.g., “1” or “0” data bit). The first information may indicate whether a WTRU is to wake up (e.g., from a sleeping state in a DRX mode, for example, a DRX idle mode or a DRX connected mode). The first information may indicate a value of a WUS (e.g., indicated by a series of data bits). The first information may be associated with a packet. For example, a number of ON/OFF symbols may constitute a packet. A packet may include one or more of the following: a payload, a synchronization signal, and/or reference signal(s).

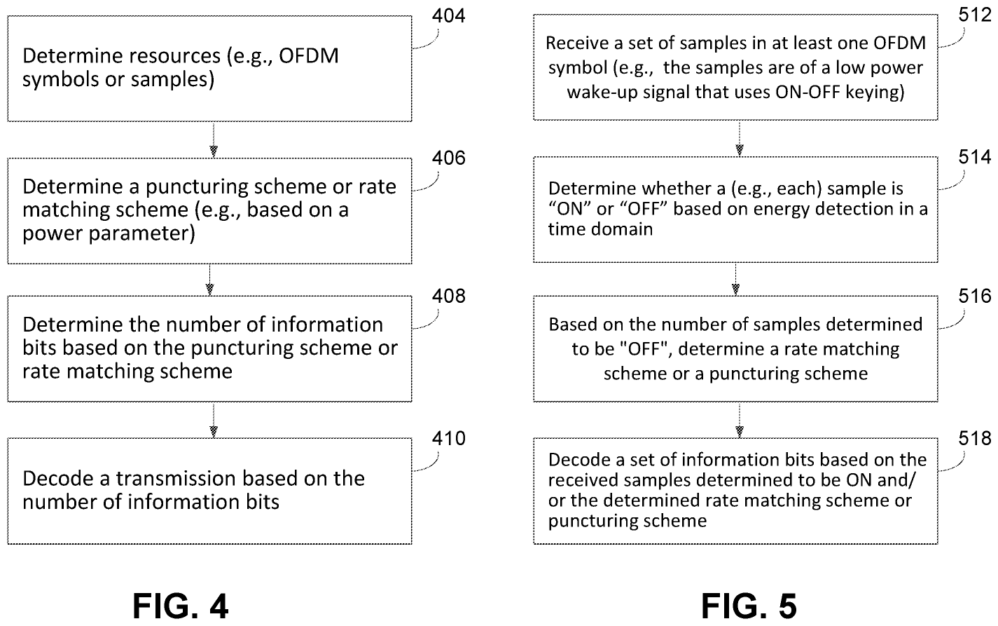

Second information (e.g., a second level of information, a second type of information, etc.) may be included in information bits (e.g., data vectors that include information other than a WUS value). In examples, the second information may be included (e.g., encoded) in the low power signal (e.g., the low power signal constituting the ON/OFF symbols). The second information may be retrieved, for example, by further processing the low power signal. The information bits may be included in the on-resource(s) of the transmission. The WTRU may determine a puncturing scheme based on the on-off resource pattern that is determined in one or more examples as described herein (e.g., as shown at 516 of FIG. 5). The WTRU may determine the number of information bits based on the puncturing scheme. The WTRU may decode the information bits based on the determination of the number of information bits (e.g., as shown at 410 of FIG. 4 or at 518 of FIG. 5). Examples of what information bits indicate may include one or more of cell information, paging, short message(s), user ID, or user data.

A transmission (e.g., the OOK signal in FIG. 2) may be generated using discrete Fourier transform spread orthogonal frequency division multiplexing (DFT-s-OFDM) modulation. In examples, the transmission may be received using a low-power receiver of a WTRU and demodulated using DFT-s-OFDM demodulation.

A transmission (e.g., the OOK signal in FIG. 2) may be generated using DFT modulation (e.g., DFT-s-OFDM modulation). In examples, a low power signal may be generated using DFT modulation. For example, the DFT-s-OFDM modulation may include OFDM modulation with transform precoding. In some examples, the low power signal may be generated using single-carrier (SC) modulation. The SC modulation may include upsampling a sequence of symbols and pulse shaping the up-sampled sequence, for example, with a filter.

A low power signal may include a signal, the entirety of which may be detected using a certain low-power receiver (e.g., a receiver that uses less power than a traditional receiver; an example of the low-power receiver may include a receiver that uses a power that is an order of magnitude, a factor, or a degree less than the power consumed by the traditional receiver).

A transmission (e.g., the OOK signal in FIG. 2) may be generated to include information bits. In examples, information bits may be coded, for example, encoded with a channel encoder. Scrambling may be applied to a code block (e.g., the code block including one or more of the information bits). Coded bits (e.g., encoded information bits) may be modulated. For example, BPSK, QPSK or a QAM modulation may be used to modulate the coded bits. The modulated bits (e.g., the modulated information bits or modulated symbols) may be transmitted using available resources (e.g., OFDM resources). The modulated bits may be transmitted, for example, over a set of REs or over at least one OFDM symbol and at least one subcarrier. The modulated bits may be transmitted according to a rate matching scheme or puncturing scheme, for example, based on the available resources. In examples, the modulated bits to be transmitted in an OFDM symbol (e.g., one OFDM symbol) may be represented as a vector of size N×1 (e.g., referred to as the data vector d). The modulated bits may be multiplexed with zeros, for example, according to a rate matching scheme. In examples, the data vector d may be multiplexed with zeros to form a vector x, for example, according to the rate matching scheme. The vector x may be modulated, for example, using DFT-s-OFDM or a SC modulation. When DFT-s-OFDM is used, the DFT of x may be mapped to a set of subcarriers, for example, before applying OFDM modulation (e.g., IDFT and/or cyclic prefix addition).

A vector that includes the data vector d and zeros may be generated, for example, according to a rate matching scheme or a puncturing scheme. In examples, the scheme (e.g., the scheme shown in formula (1) that is used to generate the vector that includes the data vector d and zeros may include a puncturing scheme (e.g., the puncturing scheme may indicate how encoded bits are punctured, for example, the number of the encoded bits that are punctured and the order in which the encoded bits are punctured). The vector x may be formed using a contiguous set of elements of the data vector d (e.g., a data chunk) and/or a contiguous set of zero elements (e.g., a zero chunk).

An example DFT is shown in FIG. 2A. The DFT size in FIG. 2A may be L (e.g., L=96). The input shown in FIG. 2A may be used to create a time domain signal as shown in FIG. 2. As shown in FIG. 2A, if the IDFT size is M (e.g., M=192), then each of the ON or OFF durations (e.g., periods) at the output of the IDFT may include 12×(M/L)=24 samples. The 12 symbols of d0 at the input of the DFT precoder may correspond to an ON duration at the output of the IDFT, the next 12 symbols of zeros at the input of the DFT precoder may correspond to an OFF duration, etc.

The DFT input (e.g., vector x=[d₀ 0 0 d₁ 0 d₂ 0 d₃]) may be generated using a puncturing scheme or a rate matching scheme. For example, in a puncturing scheme, an entity (e.g., a base station or a WTRU) may prepare, for an OFDM symbol (e.g., each OFDM symbol), N symbols to be fed into the DFT encoder. Depending on the on-off resource pattern to be generated, the input symbols (e.g., some of the N symbols) that correspond to the OFF durations may be replaced with zeros. In a rate matching scheme, the number of symbols prepared to be fed into the DFT encoder may be equal to the number of non-zero inputs.

A device (e.g., a WTRU at the receiver side) may determine the ON and OFF durations (e.g., periods), for example, using energy detection. After an M-size IDFT, subcarrier demapping, and L-size DFT, the device may determine (e.g., create an estimate of) the non-zero input symbols. The indices of the zero and non-zero symbols may be determined based on the ON/OFF symbols (e.g., the locations of the ON/OFF symbols).

Chunk(s) of the data vector may be multiplexed with chunk(s) of zero elements, for example, according to a rate matching scheme. For example, if a data vector is represented as d=[d₀ d₁ d₂ d₃], then X=[d₀ d₁ 0 0 d₂ 0 d₃ 0] may be formed. An example is shown in formula (1). Formula (1) may be used as a rate matching or puncturing scheme in one or more examples herein.

x=[d₀₀ d₀₁ . . . d_{0(L-}d₁₀ d₁₁ . . . d_{1(L-1)} 00 . . . 0 00 . . . 0 d₂₀ d₂₁ . . . d_{2(L-1)} 00 . . . 0 d₃₀ d₃₁ . . . d_{3(L-1)} 0 0 . . . 0] (1)

In the example shown in formula (1), a (e.g., each) chunk includes (e.g., consists of) L elements. The first subscript denotes the chunk index, and the second subscript denotes the element index within a chunk. di may be referred to as chunk i. For example, d₁₁ may be the second element in chunk 1. d31 may be the second element in chunk 3. In some examples, vector x may be generated using the following formula: x=[d₀ 0 d₁ 0 d₂ d₃ 0 0] or using the following formula x=[d₀ 0 0 d₁ 0 d₂ 0 d₃], which corresponds to the on-off resource pattern in FIG. 2. The sizes of chunks need not be the same. For example, chunk 1 may be associated with a first size, and chunk 3 may be associated with a second size that is different from the first size. The size of a chunk may indicate the number of elements in that chunk. A chunk (e.g., each chunk or more than one chunks) may include one or more of a prefix, a postfix, or a guard interval. One or more of the prefix, the postfix, or the guard interval may include (e.g., consisting of) a fixed set of coefficients (e.g., zeros). One or more of the prefix, the postfix, or the guard interval may be added to a (e.g., each) chunk.

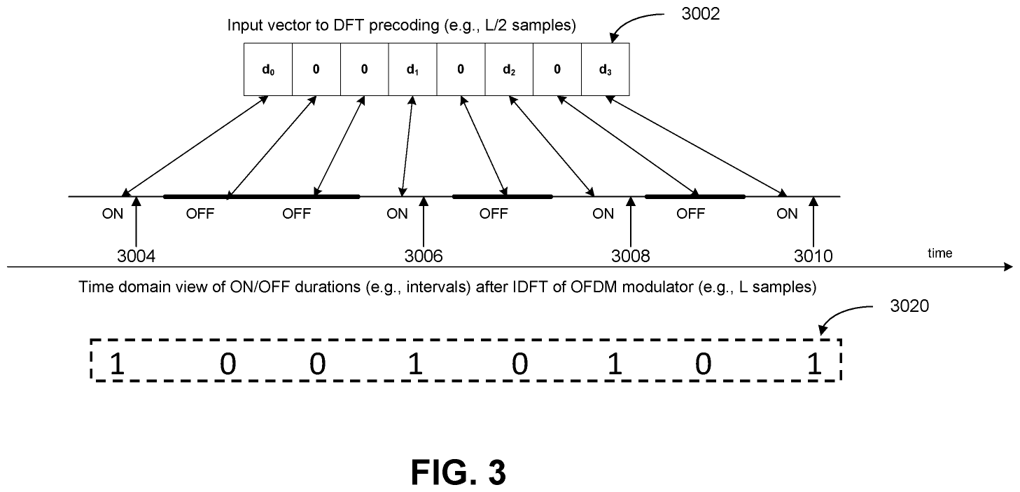

A rate matching scheme associated with an on-off resource pattern (e.g., the on-off resource pattern of the OOK signal, shown in FIG. 2) or a punching scheme associated with the on-off resource pattern may be used to transmit the information bits. In examples, the on-off resource pattern may have a one-to-one correspondence with how encoded bits are punched or how encoded bits are rate matched. For example, an on-resource may correspond to information bits (e.g., a data chunk), an off-resource may correspond to zeros (e.g., zero chunks). The puncturing scheme or the rate matching scheme may indicate one or more of the following: an order of one or more data chunks and one or more zero chunks; a pattern of the one or more data chunks and the one or more zero chunks, or a sequence of the one or more data chunks and the one or more zero chunks. In examples, the order of the data chunks and zero chunks in vector x may be determined based on the ON/OFF symbol pattern of an LP WUS signal. There may be a one-to-one mapping such that an ON symbol may correspond to a data chunk and an OFF symbol may correspond to a zero chunk, for example, as shown in FIG. 3. FIG. 3 is a diagram illustrating an example of ON/OFF durations.

The ON/OFF signal in FIG. 2 includes (e.g., consists of) ON/OFF symbols that correspond to the on-off resource pattern 3012 [ON OFF OFF ON OFF ON OFF ON]. As described herein, vector x may be generated to include 4 data chunks do-d3. As shown in FIG. 3, the vector x may be generated using the input x=[d₀ 0 0 d₁ 0 d₂ 0 d₃], for example, as a rate matching or puncturing scheme 3002. The vector x in FIG. 3 may have been generated using a WUS value 3020, which is [1 0 0 1 0 1 0 1]. The data chunks d0, d1, d2, and d3 may be inputted to the DFT precoding as input blocks (e.g., data input blocks) for the DFT precoding. 3004 may correspond to one or more on-resources (e.g., 3004 may correspond to an OFDM resource (e.g., an OFDM symbol). The on-resource(s) 3004 corresponds to data chunk d0. The on-resource(s) 3006 corresponds to data chunk d1. The on-resource(s) 3008 may correspond to data chunk d2. The on-resource(s) 3010 may correspond to data chunk d3. The off-resources in FIG. 3 may correspond to zero chunks. The diagram of FIG. 3 illustrates an example of ON/OFF durations (e.g., ON/OFF intervals after IDFT of an OFDM modulator). As shown in FIG. 3, the temporal point of an on-resource (e.g., any of the on-resource(s) 3004-3010) may be determined based on the puncturing/rate matching scheme and/or the duration of the on-resource/off-resource. As shown in FIG. 3, the number of on-resource(s) (e.g., on-resource(s) 3004-3010) and/or the number of off-resource(s) may be used to determine the puncturing/rate matching scheme.

The puncturing scheme may be used, for example, by an encoder. The puncturing scheme may indicate how encoded bits are punctured (e.g., the puncturing scheme may indicate which resources are used to transmit zeros and/or which resources are used to transmit information bits). Information bits may include the data vectors d0 d1 d2 d3 . . . dk. In examples, the encoder may determine a value of a WUS (e.g., an OOK WUS). The encoder may generate vector x based on the value of the WUS. Vector x may be generated using a formula that indicates the puncturing scheme. The encoder may determine an on-off resource pattern (e.g., the on-off resource pattern 3012 as shown in FIG. 2) for the transmission of the WUS, for example, using the determined value of the WUS. The on-off resource pattern may be used (e.g., by a decoder) to determine the puncturing scheme that is used by the encoder.

The number of information bits that are sent (e.g., in a transmission) may be indicated by the puncturing scheme or the rate matching scheme. In examples, the number of resources available (e.g., the number of DFT input resources that are not zero) may depend on the number of ON symbols. For example, in FIG. 3, L number of resources (e.g., L samples) may be used for a transmitted signal (e.g., the OOK signal in FIG. 2). Some of the L number of resources may include zeros. The other ones of the L number of resources may be used for transmitting information bits. As shown in FIG. 3, vector x including data chunks and zero chunks may be inputted to DFT precoding. The number of the input blocks (e.g., the data chunks) to the DFT precoding may be determined based on the association of an on-resource with an input block (e.g., a mapping such as the one-to-one mapping shown in FIG. 3). The order of the input blocks may be determined based on the association of an on-resource with an input block (e.g., from the one-to-one mapping shown in FIG. 3). As shown in FIG. 3, 4 on-resources (e.g., ON symbols) 3004-3010 may indicate that there are 4 input blocks (e.g., 4 data chunks or data vectors do, d1, d2, and d3) into the DFT that are available (e.g., for the OOK signal in FIG. 2).

For example, a base station (e.g., a gNB) may decide to send a WUS with a value of 10010101 over a symbol (e.g., over one symbol). The WUS value may translate to an on-off resource pattern [ON-OFF-OFF-ON-OFF-ON-OFF-ON], for example, for a symbol corresponding to 8X time samples. An “ON” (e.g., an on-resource) may correspond to X samples, and an “OFF” (e.g., an off-resource) may correspond to X samples. The base station may use the ON samples to send information bits (e.g., data vectors). The number of samples available for transmitting and/or receiving the information bits may change (e.g., dynamically), for example, based on the WUS value. As shown in FIG. 3, 4 on-resources 3004-3010 may provide 4X samples for the transmission of information bits. The base station may encode the information bits. The base station may puncture the encoded bits or rate-match the encoded bits based on, for example, a DFT size. For example, the base station may fit (e.g., by rate matching or puncturing) the encoded information bits in 4X/2 samples (e.g., divided by 2 based on the DFT size).

In some examples, if each input block consists of 12 QPSK modulation symbols, there may be 12*4=48 QPSK symbols, making 96 bits (e.g., since QPSK modulation transmits two bits per symbol). The number of encoded bits may be more than 96 bits. The information bits may be coded (e.g., encoded), and/or the coded bits may be punctured properly so that the information bits fit into the available resources (e.g., the resources as determined at 404 of FIG. 4 or the set of samples as received at 512 of FIG. 5). For example, if the number of coded (e.g., encoded) bits is 192, 96 of the 192 bits (i.e., 192−96=96) may be (e.g., need to be) punctured (e.g., since only 96 bits are to be transmitted to include information bits).

In examples, a modulated code block may be transmitted over K (e.g., K=14) OFDM symbols, and a data vector dk (k=0, . . . , K−1) may be mapped to the kth OFDM symbol. In some examples, coded bits (e.g., encoded bits) may first be punctured before being modulated. The puncturing may be performed, for example, such that bits that do not get punctured may constitute dk.

A WTRU may determine resources allocated for an OOK signal. The resources may be OFDM resources (e.g., a set of REs or over at least one OFDM symbol and at least one subcarrier). For example, the OFDM resources may be scheduled for a reception of an OOK WUS. The WTRU may receive configuration information that indicates the resources and/or determine the resources dynamically.

A WTRU may determine a rate matching scheme or a puncturing scheme (e.g., the puncturing scheme used by an encoder) based on a power parameter (e.g., as shown at 406 or FIG. 4). For example, at the receiver, a transmission (e.g., an LP WUS signal such as an OOK LP WUS signal) may first be processed to identify the ON/OFF symbols. The ON/OFF symbols may be identified by an energy detection, for example, using a power parameter. The ON/OFF symbols may be determined as shown at 514 of FIG. 5. The power parameter may include one or more of an average power over a duration of an ON symbol, a total power over a duration of an ON symbol, an average power over a duration of an OFF symbol, a total power over a duration of an OFF symbol, a power variation from the average power of the ON symbol to the average power of the OFF symbol, a power variation from the total power of the ON symbol to the total power of the OFF symbol, or a transmission power threshold. In examples, a transmission power threshold may be a predetermined or predefined value.

The WTRU may determine data bits indicated by the ON/OFF symbols (e.g., the data bits encoded by the ON/OFF symbols). The data bits indicated by the ON/OFF symbols may contain the first level of information associated with the transmission. The WTRU may determine the data bits indicated by the ON/OFF symbols using the association of a first data bit (e.g., a data bit “1”) with an ON symbol and/or the association of a second data bit (e.g., a data bit “0”) with an OFF symbol, for example, the mapping between ON/OFF symbols and data bits.

The WTRU (e.g., on the receiving side) may determine information bits (e.g., data vectors) based on the puncturing scheme (e.g., as shown at 408 of FIG. 4). The information bits may include the second level of information associated with the transmission. The second level of information associated with the transmission may be extracted, for example, using further processing. DFT-s-OFDM demodulation or SC demodulation may be used to determine the information bits. For example, a DFT-s-OFDM receiver or a SC receiver may be used to estimate the data vector d. The rate matching scheme or the puncturing scheme may be used to determine the information bits (e.g., data vector d) and/or information related to the information bits, for example, including one or more of the number of data chunks that contain information bits, the number of zero chunks, or the order of the data chunks and zero chunks. For example, to estimate d, the WTRU may, using the rate matching scheme or the puncturing scheme, obtain the indices (e.g., of vector x) that correspond to data chunks and/or indices that correspond to zeros. In some examples, the WTRU may need to know such indices. This information may be available from the ON/OFF symbols detected (e.g., using energy detection in the first step). The WTRU may determine the number of data chunks that contain information bits, the number of zero chunks, and/or the order of the data chunks and zero chunks based on the rate matching or puncturing scheme that has been determined based on the power parameter. As an example, if the WTRU estimates the ON/OFF symbols shown in FIG. 3, then the WTRU may determine the indices that correspond to dᵢ and zeros using the association of an on-resource with a data chunk and/or the association of an off-resource with a zero chunk (e.g., the one-to-one mapping shown in FIG. 3). The WTRU may obtain modulation information (e.g., the WTRU may need to know the modulation information in some instances). For example, the modulation information may include the size of the inverse discrete Fourier transform (IDFT) and/or the DFT. As an example, if the size of the IDFT is 1024, each ON/OFF symbols consists of 64 samples, the size of DFT is 256, then each chunk may contain 16 samples (i.e., (256/1024)*64=16). If a cyclic prefix/postfix or a guard interval are present, the samples corresponding to the cyclic prefix/postfix or a guard interval may be discarded.

FIG. 4 illustrates an example of a determination (e.g., a dynamic determination) of the number of information bits. At 404, a device may determine resources (e.g., OFDM symbols or samples), for example, for a transmitted OOK signal. At 406, the device may determine a puncturing scheme or rate matching scheme, for example, based on a power parameter. At 408, the device may determine the number of information bits based on the puncturing scheme or rate matching scheme. At 410, the device may decode a transmission based on the number of information bits.

FIG. 5 illustrates an example of a determination (e.g., a dynamic determination) of the number of information bits. FIG. 5 illustrates an example of FIG. 4. At 512, a device may receive a set of samples in at least one OFDM symbol (e.g., the samples may be of a low power wake-up signal that uses ON-OFF keying). At 514, the device may determine whether a (e.g., each) sample is “ON” or “OFF” based on energy detection in a time domain. Based on the number of samples determined to be “OFF”, the device may determine a rate matching scheme or a puncturing scheme (e.g., the scheme used by the transmitter after encoding a set of information bits) at 516. At 518, the device may decode a set of information bits based on the received samples determined to be ON and/or the determined rate matching scheme or puncturing scheme.

In examples, at least one chunk (e.g., a data chunk) may be allocated for data demodulation reference signal(s) (DM-RS(s)) (e.g., transmission or reception of DM-RS(s)). In some examples, DM-RS(s) may be transmitted using separate DFT-s-OFDM or SC symbol(s). In this case, an OOK signal may include ON symbols (e.g., consist of only ON symbols).

In examples, the WUS (e.g., the LP WUS) may be generated, for example, by masking a single carrier or a multicarrier signal. For example, an OFDM signal may be generated. The OFDM signal then may be pointwise multiplied with a mask (e.g., where the mask may consist of ones and zeros). A cyclic prefix may be added after the masking operation. A guard interval may be added, for example, before or after an ON/OFF symbol.

In examples, the second information (e.g., the second level of information used to generate the OFDM signal) may be determined based on a sequence (e.g., determined from a pseudo-random sequence). For example, the sequence (e.g., the pseudo-random sequence) may be generated based on (e.g., as a function of) at least one system parameter. In one or more examples, the sequence may be initialized using at least one of a symbol index (e.g., the current OFDM symbol index), a slot index (e.g., the current slot index), a system frame number (SFN) (e.g., the current SFN), a cell-ID (e.g., the current cell-ID), etc. In some examples, the second level of information may be conveyed and/or determined by applying a cyclic shift to a pseudo-random sequence. The cyclic shift may be determined, for example, per OFDM symbol index or per slot index. In one or more examples, the cyclic shift may be determined based on (e.g., as a function of) at least one of a symbol index (e.g., the current OFDM symbol index), a slot index (e.g., the current slot index), an SFN (e.g., the current SFN), a cell-ID (e.g., the current cell-ID), etc. In some examples, the second level of information may be conveyed and/or determined by applying a cyclic shift to a fixed sequence. The cyclic shift applied to the fixed sequence may be determined, for example, per OFDM symbol index or per slot index. The cyclic shift applied to the fixed sequence may be determined based on (e.g., as a function of) at least one of a symbol index (e.g., the current OFDM symbol index), a slot index (e.g., the current slot index), an SFN (e.g., the current SFN), a cell-ID (e.g., the current cell-ID), etc. The fixed sequence may be determined, for example, at least from the cell-ID.

The ON/OFF symbols may be repeated in an OFDM symbol (e.g., one OFDM symbol) or across OFDM symbols. When repetition(s) is applied, ON/OFF symbols may be flipped, for example, per OFDM symbol. For example, in a first OFDM symbol, [ON ON OFF ON OFF] (e.g., with a value of [1 1 0 1 0]) may be transmitted, and, in a second OFDM symbol, [OFF OFF ON OFF ON] (e.g., with a value of [0 0 1 0 1]) may be transmitted.

Contents of data and ON/OFF symbols may vary in one or more examples herein. Other waveforms (e.g., OFDM with masking) may be used in one or more examples herein. In one or more examples herein, the first level of information may be used as an example of the first information or the first type of information. The first information, the first level of information, or the first type of information may be used interchangeably in one or more examples herein. In one or more examples herein, the second level of information may be used as an example of the second information or the second type of information. The second information, the second level of information, or the second type of information may be used interchangeably in one or more examples herein.

The first level of information may include (e.g., consists of) a wake-up indication, and the second level of information may be associated with a WTRU ID (e.g., a group ID). For example, a WTRU may determine a wake-up indication based on or from the first level of information. The WTRU may further determine, based on or from the second level of information, a wake-up indication (e.g., the indication to wake-up or not) for the group ID and/or for the WTRU ID with which the WTRU is associated.

The first level of information and the second level of information may be associated with an ID (e.g., a WTRU group ID). For example, a part of the ID may be transmitted in the first level of information and another part of the ID may be transmitted in the second level of information. A specific combination of the first level of information and the second level of information may be used to wake-up a group of WTRUs. For example, the same WTRU group ID information may be sent as part of the first level of information and as part of the second level of information, indicating the WTRUs associated with the group ID (e.g., belonging to that group ID) to wake up.

The second level of information may include (e.g., consists of) WTRU specific data. For example, the second level of information may be targeting a second WTRU (e.g., a WTRU operating in non-low power mode or a WTRU whose low-power receiver is deactivated). In examples, a first WTRU may receive an OOK signal using a low-power receiver. The OOK signal received by the first WTRU may include the first level of information and the second level of information. The second level of information may be targeting the second WTRU. The second level of information may be used for the coexistence of the first WTRU and the second WTRU. The second WTRU (e.g., the WTRU operating in a low power mode) may first determine the ON/OFF symbol pattern of a WUS (e.g., the LP WUS). The second WTRU may process the WUS, and the second WTRU may detect the information bits, for example, using the mapping between the ON/OFF symbols and the information bits.

Information bits (e.g., the second level of information in one or more examples herein) embedded in a WUS (e.g., LP WUS) and data bits represented by the ON/OFF symbols (e.g., the first level of information in one or more examples herein) may be related. For example, the information bits embedded in the WUS and the data bits represented by the ON/OFF symbols may include the same information. ON/OFF symbols may be encoded and transmitted, for example, to add a layer of security. The WTRU may first determine the ON/OFF symbols. Using the ON/OFF symbols, the WTRU may determine the association of ON symbols to the information bits (e.g., a mapping of ON symbols to the information bits) and/or extract the information bits. If the information bits embedded in the WUS and the data bits represented by the ON/OFF symbols match, the WTRU may process the information bits. If at least one cyclic redundancy check (CRC) associated with the information bits passes, the WTRU may process the corresponding bits. If one information bit (e.g., only one information bit) has CRC, the WTRU may check that CRC.

Data (e.g., the information bits in one or more examples herein) may include cell-common information. For example, the data may include configuration(s) (e.g., cell ID(s).

The first level of information in one or more examples herein may be a signal (e.g., a signal used for synchronization).

The second level of information in one or more examples herein may be paging information (e.g., short message(s)).

The second level of information may be decoded based on a WTRU capability. For example, a WTRU with a DFT-s-OFDM receiver or a receiver that has a capability to process multiple levels of information (e.g., the first level of information and the second level of information) may decode the second level of information. The second level of information may be processed (e.g., encoded or decoded) using a modulation and coding scheme (MCS) (e.g., a fixed MCS). The WTRU capability may be reported by the WTRU, for example, to a base station (e.g., the gNB).

A packet for a WUS (e.g., an LP WUS) may be defined. A packet may include (e.g., consist of) a number of ON/OFF symbols where the ON/OFF symbols may represent data (e.g., a payload) and/or physical signals (e.g., synchronization (SYNC) signals, reference signals). Certain packets may be transmitted periodically. These packets may contain cell common information (e.g., system information).

Different data rates may be supported for ON/OFF keying modulation, for example, by using different symbol duration(s). For example, an ON/OFF symbol duration may be reduced to support a higher data rate. The data rate may be indicated in a periodic signal (e.g., the periodically transmitted signal). The periodic signal may be transmitted with a certain data rate (e.g., a fixed data rate). As an example, the fixed data rate may be configured while the WTRU is operating in a certain power mode (e.g., a regular power mode such as a non-low power mode). The data rate may be indicated with a common signal (e.g., the SYNC signal).

In some examples, for in-band WUS monitoring, the WTRU may monitor for a WUS (e.g., an LP WUS), for example, at a specific frequency location of a CORESET size for a specific sequence that may be of sounding reference signal (SRS) type. This sequence may be transmitted, for example, over 2 or 3 symbols, and/or may be orthogonal with the sequence's own shifted versions. For example, this sequence may have the same coverage properties as the PDCCH channel of the cell. The sequence may be scrambled, for example, with the cell-ID or a different cell identifier. The sequence (e.g., the WUS sequence) may be sent, for example, at a specific time location driven by the cell SFN and the slot number. The WTRU may maintain the WTRU's cell synchronization. The sequence may be shifted, relative to the seed of the sequence (e.g., shifted every occurrence with a known number relative to the seed of the sequence). While detecting a certain sequence shift, the WTRU may know (e.g., based on the certain sequence shift) that the WTRU belongs to the same cell and/or, for example, based on the detection of the certain sequence shift, may increase the SFN and/or the slot count. The sequence shift may be applied to some or all WUS symbols, or different shifts may be applied to a (e.g., each) WUS symbol, for example, increasing the synchronization information transferred to the WTRU or a WUS message coding (e.g., a message coding such as Wake Up, Go to Sleep). In examples, the WUS (e.g., the LP WUS) may have a mask applied to the symbols of the WUS in a frequency domain or one of the symbols in the frequency domain to indicate other information (e.g., group-ID wake up). In some examples, different mask(s) may be applied in different symbol(s) (e.g., a different mask applied to each symbol in the frequency domain). The amount of information transferred to the WTRU may be increased. The mask may be applied in a way that the orthogonality of the sequences is maintained. In examples, the base station (e.g., the gNB) may configure the WTRU with one or more of the following: the WUS sequence(s); the number of symbols to monitor; the frequency region(s) for monitoring; the time domain occurrence(s); possibly related mask(s). The configuration information may be signaled in system information block(s) (SIB(s) or via dedicated signaling.

Configuration of WUS(s) (e.g., LP WUS(s)) may include, for example, activation or deactivation. Configuration information of the WUS (e.g., the LP WUS) may be transmitted (e.g., by the gNB in the system information), for example in a SIB and/or in higher layer signaling (e.g., RRC signaling). The configured WUS may be activated or deactivated. If the configured WUS (e.g., the LP WUS) is activated, a WTRU may expect that the configured WUS is transmitted in the associated resources. If the configured WUS (e.g., the LP WUS) is deactivated, the WTRU may expect that the configured WUS is not transmitted in the associated resources and/or the configured WUS ceases to be transmitted.

An activation and/or deactivation indication may be transmitted (e.g., by a base station) using at least one of the following and/or a combination of the following.

The activation and/or deactivation indication may be carried in a paging PDCCH (e.g., a PDCCH transmission). For example, the activation and/or deactivation may be indicated with a bit (e.g., “1” indicates activation, “0” indicates deactivation) in the short message within the paging PDCCH. The activation and/or deactivation may be indicated with a bit in the paging PDCCH (e.g., via bits reserved for other than the short message).

The activation and/or deactivation indication may be carried in a SIB.

The activation and/or deactivation indication may be carried in a common control channel (e.g., a common control channel transmission) or a group common control channel (e.g., a group common control channel transmission). The control channel may be monitored with a specific RNTI. In examples, a WTRU may be configured with the monitoring occasions of the control channel. A WTRU may be configured with the location of indication bit(s) within the DCI, and/or the WTRU may determine the location of the bits using a WTRU specific parameter (e.g., the WTRU ID).

The activation and/or deactivation indication may be carried in a WTRU specific control channel (e.g., a WTRU specific control channel transmission).

The activation and/or deactivation indication may be carried in a medium access control control element (MAC CE).

The activation and/or deactivation indication may be carried with the LP WUS. In an example, the indication may be carried in a WUS payload (e.g., as part of the first information in one or more examples herein). The payload may be part of common signaling (e.g., potentially monitored by some or all WTRUs), group common signaling (e.g., potentially monitored by a group of WTRUs), or WTRU specific signaling. A WTRU, based on a determination that a deactivation indication has been received (e.g., based on a value of the activation-deactivation indication), may stop monitoring the LP WUS (e.g., by deactivating the low-power receiver) and/or send an indication (e.g., to the main receiver, which is the receiver other than a low-power receiver) to turn on or activate the main receiver. The indication may be carried in a physical signal. For example, a WTRU may determine that a deactivation indication has been received if a specific SYNC signal is detected. The SYNC signal may be part of a preamble and/or may be transmitted periodically, for example, for synchronization purposes.

A WTRU may determine to monitor the LP WUS based on receiving the activation indication. A WTRU may determine not to monitor the low power signal based on receiving the deactivation indication. A WTRU that determines and/or is indicated to monitor a low power signal (e.g., the LP WUS) may determine to turn off or deactivate the main receiver and/or may determine to operate the main receiver in a power saving mode (e.g., a low power mode).

Whether a WTRU is to start monitoring an LP WUS may be indicated to the WTRU. In examples, an indication (e.g., a “go-to-sleep” (GTS) indication) may be used to indicated to the WTRU whether to start monitoring the LP WUS or not. The WTRU, based on receiving the GTS indication, may start monitoring the LP WUS, for example, after a delay. When the WTRU is indicated to monitor the LP WUS, the WTRU may be expected to turn off or deactivate the main receiver and not to receive signal(s) (e.g., not receive any signal). When the WTRU is indicated to monitor the LP WUS, the WTRU may be expected to turn off or deactivate the channel associated with the main receiver. When the WTRU is indicated to monitor the LP WUS, the WTRU may be expected to operate the main receiver in a power saving mode.

In examples, a base station (e.g., the gNB) may indicate to the WTRU whether to go to sleep (e.g., with a one-bit indication: bit “1” may indicate go-to-sleep; bit “0” may indicate not to go to sleep). In examples, the WTRU may be expected to acknowledge the reception of the indication. The indication may be transmitted in a PDCCH transmission (e.g., WTRU specific information or WTRU group common information) and/or a MAC CE. One or more examples herein for activation/deactivation of the WUS may be applicable to a GTS indication. In some examples, the activation/deactivation indication and the GTS indication may refer to the same signal. The WTRU may start monitoring the LP WUS, for example, after a delay from the time when the acknowledgment of the reception of the GTS indication is sent.

In examples, a WUS (e.g., an LP WUS) may be used by WTRU(s) with predefined condition(s), (e.g., WTRU(s) with a low mobility and/or a good coverage). The WTRU(s) may perform measurement(s) including one or more of the following: reference signal received power (RSRP), velocity, position, etc. These measurements may be reported to a base station (e.g., the gNB), which then may send a GTS indication to the WTRU.

In some examples, a WTRU may indicate to the base station (e.g., the gNB) a decision, e.g., based on measurements. The decision may include a decision of whether it is feasible to use an LP WUS. After the WTRU indicates to the base station the decision, the WTRU may wait for a GTS indication.

In examples, A WTRU may send a request to the base station to indicate that the WTRU is to go to sleep. A request (e.g., the request to go to sleep) may be transmitted, for example, using one or more of the following: random access channel (RACH) transmission(s); physical uplink control channel (PUCCH) transmission(s); MAC CE. Preconfigured resource(s) may be used for the request. An explicit or implicit acknowledgment may be sent, for example, by the base station. In an example, for contention free physical random access channel (PRACH), the request may be sent in message 2. For contention based PRACH, the request may be sent in message 2 or 4. For example, a contention resolution may indicate GTS.

A WTRU may make measurement(s) in a low power mode. For example, the WTRU may use the SYNC signal and/or other reference signals to make the measurement(s). If the power (e.g., the average power, a total power, etc.) of a signal or some other measurement(s) related to the signal is below a threshold, for example, possibly over a time interval, the WTRU may indicate to the main receiver to wake-up. This may be periodically assessed. The WTRU may be configured with one or more of the following: threshold(s), time interval(s), measurement period(s), etc. After the WTRU wakes up, a wake-up indication may be transmitted to the base station (e.g., the gNB). In examples, a WTRU ID may be used for the wake-up indication. As an example, the WTRU ID used for the wake-up indication may be the ID used while the WTRU is in the low power mode. A WTRU may acknowledge waking up, for example, by responding to a WUS (e.g., an LP WUS sent by a gNB) with a non-LP WUS indication within a maximum acknowledge period after re-establishing the connected mode. If the WTRU fails to acknowledge the wake-up, the base station (e.g., the gNB) may resend the WUS, for example, at the same data rate or reduce the data rate if possible.

A WTRU may be configured to monitor the WUS (e.g., the LP WUS), for example, in a subband of a BWP. The BWP may be one or more of the following: the initial BWP; the active BWP; a specific BWP (e.g., a BWP that is allocated to the LP WUS). A WTRU may be configured with a low power signal. A WTRU may determine to use the BW (e.g., a BWP) in which the low power signal is determined, for example, for LP WUS monitoring. For example, 4 subbands of a BWP may be configured for possible LP WUS monitoring. A SYNC signal may have the format [z z]; [z −z]; [−z −z]; [−z z]. The WTRU may be configured with one of these and/or use the BWP in which that SYNC signal is detected. The SYNC signal may be included in a preamble or may be synchronization signal block (SSB)-like. The SYNC signal may be included in other physical signal(s). The SYNC signal may be a sequence itself, for example, as a function of a subband index or a configured index. In examples, one or more subbands may be scanned, for example, until a match is found.

The subband to monitor may be determined, for example, based on the WTRU group ID (e.g., by the WTRU group ID). A subband (e.g., each subband) may be associated with an index within a BWP and/or a channel. The index may be transmitted using physical signal(s) (e.g., SYNC in SSB-like and/or preamble), reference signal(s), and/or payload (e.g., in a header). A WTRU may determine an index (e.g., the correct index) to monitor.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
determine a plurality of orthogonal frequency division multiplexing (OFDM) resources;
determine, based on a power parameter associated with a transmission, a puncturing scheme associated with the plurality of OFDM resources, wherein the puncturing scheme represents an on-off keying associated with an on-off keyed (OOK) wake-up signal in the transmission;
determine, based on the puncturing scheme, a number of information bits associated with the plurality of OFDM resources; and
decode the transmission based on the number of information bits.

17. The WTRU of claim 16, wherein an on-off pattern of the puncturing scheme matches the on-off keying associated with the OOK wake-up signal.

18. The WTRU of claim 16, wherein the processor is further configured to:
determine an on-resource of the plurality of OFDM resources and an off-resource of the plurality of OFDM resources based on a transmission power threshold, and wherein the puncturing scheme is determined further based on the determined on-resource and off-resource.

19. The WTRU of claim 18, wherein the on-resource is associated with a first average transmission power over a duration of the on-resource, wherein the power parameter associated with the transmission comprises the first average transmission power, wherein the off-resource is associated with a second average transmission power over a duration of the off-resource, wherein the first average transmission power is greater than or equal to the transmission power threshold, and wherein the second average transmission power is less than the transmission power threshold.

20. The WTRU of claim 18, wherein the processor is further configured to determine an on-off resource pattern based on a plurality of power variations associated with the transmission, and wherein the puncturing scheme is determined further based on the on-off resource pattern.

21. The WTRU of claim 18, wherein the processor is further configured to determine, based on the puncturing scheme, a temporal point associated with the on-resource, and wherein the transmission is decoded based on the temporal point associated with the on-resource.

22. The WTRU of claim 16, wherein the processor is further configured to:
determine a number of on-resources of the plurality of OFDM resources and a number of off-resources of the plurality of OFDM resources based on a transmission power threshold, wherein the puncturing scheme is determined further based on the number of on-resources and the number of off-resources.

23. The WTRU of claim 16, wherein the transmission comprises the OOK wake-up signal, and the OOK wake-up signal indicates whether the WTRU is to wake up in a discontinuous reception (DRX) mode.

24. The WTRU of claim 23, wherein the transmission comprises first information and second information, wherein the first information is indicated by the on-off keying associated with the OOK wake-up signal and indicates whether the WTRU is to wake up in the DRX mode, wherein the second information comprises the information bits, and wherein the information bits indicate an identifier associated with the WTRU.

25. The WTRU of claim 24, wherein the WTRU further comprises a receiver and a low-power receiver, wherein the first information further comprises an activation-deactivation indication, and wherein the activation-deactivation indication indicates whether the WTRU is to deactivate the low-power receiver and activate the receiver.

26. The WTRU of claim 16, wherein the plurality of OFDM resources is associated with an OFDM symbol.

27. A method performed by a wireless transmit/receive unit (WTRU), comprising:
determining a plurality of orthogonal frequency division multiplexing (OFDM) resources;
determining, based on a power parameter associated with a transmission, a puncturing scheme associated with the plurality of OFDM resources, wherein the puncturing scheme represents an on-off keying associated with an on-off keyed (OOK) wake-up signal in the transmission;
determining, based on the puncturing scheme, a number of information bits associated with the plurality of OFDM resources; and
decoding the transmission based on the number of information bits.

28. The method of claim 27, wherein an on-off pattern of the puncturing scheme matches the on-off keying associated with the OOK wake-up signal.

29. The method of claim 27, further comprising:
determining an on-resource of the plurality of OFDM resources and an off-resource of the plurality of OFDM resources based on a transmission power threshold, and wherein the puncturing scheme is determined further based on the determined on-resource and off-resource.

30. The method of claim 29, wherein the on-resource is associated with a first average transmission power over a duration of the on-resource, wherein the power parameter associated with the transmission comprises the first average transmission power, wherein the off-resource is associated with a second average transmission power over a duration of the off-resource, wherein the first average transmission power is greater than or equal to the transmission power threshold, and wherein the second average transmission power is less than the transmission power threshold.

31. The method of claim 29, further comprising determining an on-off resource pattern based on a plurality of power variations associated with the transmission, and wherein the puncturing scheme is determined further based on the on-off resource pattern.

32. The method of claim 27, further comprising:
determining a number of on-resources of the plurality of OFDM resources and a number of off-resources of the plurality of OFDM resources based on a transmission power threshold, wherein the puncturing scheme is determined further based on the number of on-resources and the number of off-resources.

33. The method of claim 27, wherein the transmission comprises first information and second information, wherein the first information is indicated by the on-off keying associated with the OOK wake-up signal and indicates whether the WTRU is to wake up in a discontinuous reception (DRX) mode, wherein the second information comprises the information bits, and wherein the information bits indicate an identifier associated with the WTRU.

34. The method of claim 33, wherein the first information further comprises an activation-deactivation indication, and wherein the activation-deactivation indication indicates whether a low-power receiver associated with the WTRU is to be deactivated.

35. The method of claim 27, wherein the plurality of OFDM resources is associated with an OFDM symbol.
